(19) United States
(12) Patent Application Publication
(10) Pub. No.: US 2012/0182517 A1
(43) Pub. Date: Jul. 19, 2012

(54) METHOD FOR MANUFACTURING MICRO RETARDER WITHOUT ALIGNMENT LAYER

(76) Inventors: Chun-Wei Su, New Taipei City (TW); Jan-Tien Lien, Keelung City (TW)

(21) Appl. No.: 13/182,452

(22) Filed: Jul. 14, 2011

(30) Foreign Application Priority Data
Jan. 14, 2011 (TW) 100101345

(51) Int. Cl. G02F 1/1337

(52) U.S. Cl. 349/191

(57) ABSTRACT

A method for manufacturing a micro retarder without alignment layer includes providing a substrate, forming a liquid crystal (LC) layer having a plurality of LC molecules, a plurality of photosensitive monomers and a plurality of thermal reactive monomers, performing a first exposure treatment to form at least a first patterned retarder in the LC layer, performing a second exposure treatment to form at least a second patterned retarder in the LC layer, and performing a baking treatment to form the micro retarder without alignment layer.

### BACKGROUND OF THE INVENTION

1. Field of the Invention

The present invention is related to a method for manufacturing a micro retarder without alignment layer, and more particularly, to a method for manufacturing a micro retarder without alignment layer adopting photo-alignment technique.

2. Description of the Prior Art

Liquid crystal display (LCD) devices have been most widely used in the field for electronic products such as mobile phones, notebook computers, digital cameras, projector, and so on due to their lightweight and low power consumption. With the progress of display technique, it is required to display 3D stereoscopic images in the conventional 2D display environment for giving vivid visual representation.

However, retardation films or micro retarders are always needed in the conventional LCD device or the LCD device that is able to present 3D images to viewers. Please refer to FIG. 1, which is a cross-sectional view of a conventional micro retarder. As shown in FIG. 1, the conventional micro retarder 100 is typically a multilayered structure having at least three layers. The multilayered micro retarder 100 includes a transparent substrate 102 such as a polymer transparent substrate and an alignment layer 104 such as a polyimide (hereinafter abbreviated as PI) layer formed thereon. According to the prior art, a rubbing alignment process is performed to the PI layer after forming the PI layer. Thus a plurality of micro grooves arranged along the rubbing direction is formed. In addition, the main chains and side-chains of the PI layer also arrange along the rubbing direction after the rubbing alignment process. Consequently, an alignment layer 104 as shown in FIG. 1 is obtained. Then, an optically anisotropic layer such as a liquid crystal (LC) layer 106 is formed on the alignment layer 104. Subsequently, a curing treatment is performed to the LC layer 106. During the curing treatment, the micro grooves of the alignment layer 104 provide anchoring energies to the LC molecules (not shown) of the LCD layer 106, thus long axis of the LC molecules arrange along the micro grooves and obtain a direction. In addition, acting forces between the polymer of the alignment layer 104 and the LC molecules of the LC layer 106 also makes the LC molecules obtain the direction. Accordingly, the micro retarder 100 which is able to provide phase retardation is formed.

However, it is found that the micro retarder 100 formed by the conventional rubbing alignment process always suffers static electricity, contamination from rubbing cloth breakage, or rubbing scores.

### SUMMARY OF THE INVENTION

Therefore, the present invention provides a method for manufacturing a micro retarder without alignment layer and without performing the rubbing alignment process.

According to a first aspect of the present invention, a method for manufacturing a micro retarder without alignment layer is provided. The method includes providing a substrate; forming a LC layer on the substrate, the LC layer comprising a plurality of LC molecules, a plurality of photosensitive monomers, and a plurality of thermal reactive monomers; performing a first exposure treatment to form at least a first patterned retarder in the LC layer; performing a second exposure treatment to form at least a second patterned retarder in the LC layer; and performing a baking treatment to form the micro retarder without alignment layer.

According to a second aspect of the present invention, a method for manufacturing a micro retarder without alignment layer is provided. The method includes providing a substrate; forming an LC layer on the substrate, the LC layer comprising a plurality of LC molecules, a plurality of photosensitive monomer, and a plurality of photo reactive monomers; performing a first exposure treatment to form at least a first patterned retarder in the LC layer; and performing a second exposure treatment to form at least a second patterned retarder in the LC layer.

According to the method for forming a micro retarder without alignment layer provided by the present invention, a LC layer having the LC molecules, the photosensitive monomers, and the thermal reactive monomers, or a LC layer having the LC molecules, the photosensitive monomers, and the photo reactive monomers is provided. Accordingly, the photosensitive monomers and the LC molecules in the LC layer are polymerized and arranged toward different exposure directions by performing the exposure treatments. Thus the first patterned retarder and the second patterned retarder are formed. And because the provided LC layer further includes the thermal reactive monomers, the micro retarder without alignment layer is formed by performing the baking treatment after forming the first patterned retarder and the second patterned retarder. Furthermore, in the preferred embodiment that the LC layer includes photo reactive monomers, the micro retarder without alignment layer is immediately obtained after forming the first exposure treatment and the second exposure treatment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view of a conventional micro retarder.

FIGS. 2-6 are drawings illustrating a method for forming a micro retarder without alignment layer provided by a first preferred embodiment of the present invention, wherein FIG. 2 is a flow chart of the method for forming a micro retarder without alignment layer.

FIGS. 7-10 are drawings illustrating a method for forming a micro retarder without alignment layer provided by a second preferred embodiment of the present invention, wherein FIG. 7 is a flow chart of the method for forming a micro retarder without alignment layer.

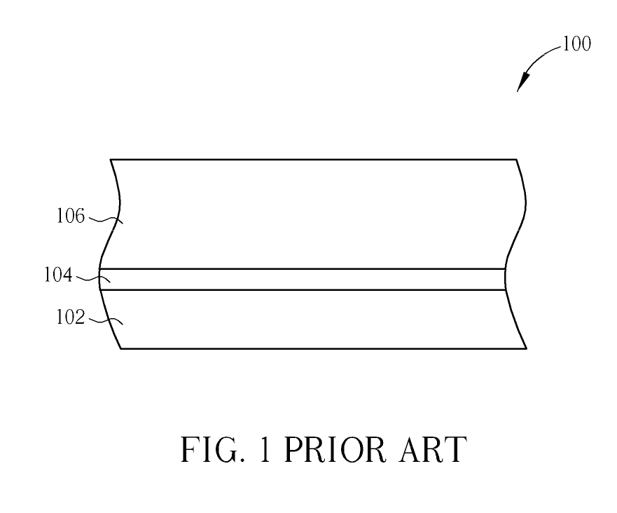

### DETAILED DESCRIPTION

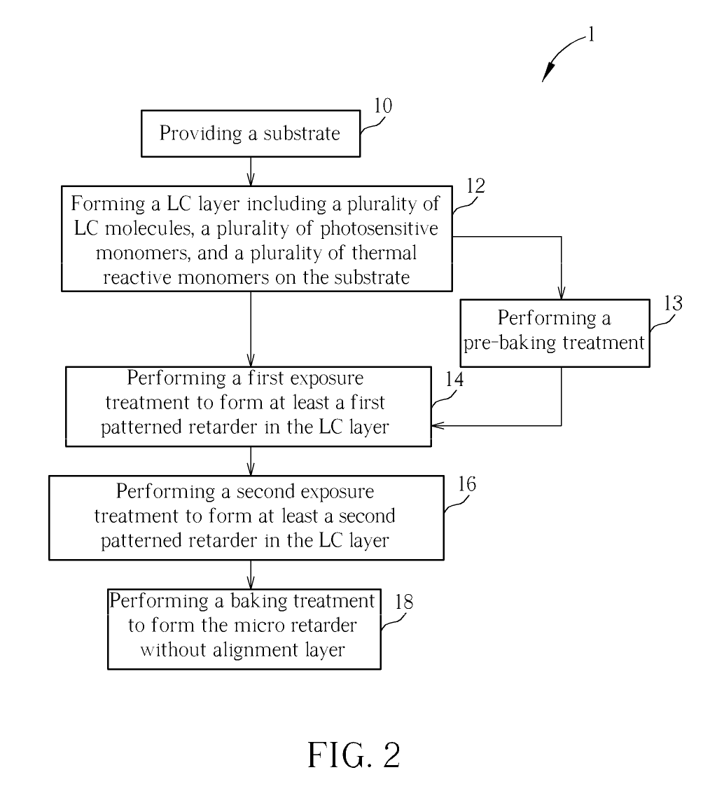

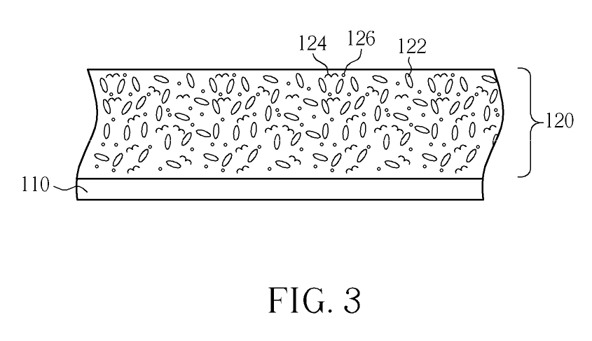

Please refer to FIGS. 2-6, which are drawings illustrating a method for forming a micro retarder without alignment layer provided by a first preferred embodiment of the present invention, wherein FIG. 2 is a flow chart of the method for forming a micro retarder without alignment layer. Please refer to FIGS. 2-3. According to the method for forming micro retarder without alignment layer 1 provided by the preferred embodiment, a Step 10 is performed: providing a substrate 110. The substrate 110 exemplarily includes polyamide-imide (PAI), polyamide, polyetherimide (PEI), or triacetyl cellulose (TAC). However, those skilled in the art would easily realize that other suitable materials can be used to form the substrate 110.

Please still refer to FIGS. 2-3. A Step 12 is subsequently performed: forming a LC layer 120 on the substrate 110. The LC layer 120 includes a plurality of LC molecules 122, a plurality of photosensitive monomers 124, a plurality of thermal reactive monomers 126, and solvent (not shown). The LC layer 120 is formed on the substrate 110 by, for example but not limited to, spin coating, dip coating, or spray coating. Consequently, the LC layer 120 obtains a uniform thickness. It is noteworthy that the LC molecules 122 include at least a pair of symmetrical base, the photosensitive monomers 124 include at least cinnamate or coumadin, and the thermal reactive monomers 126 include at least styrene or styrene derivative according to the preferred embodiment.

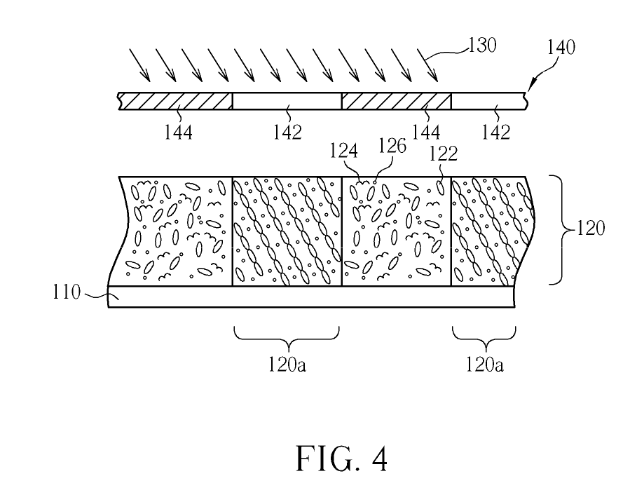

Please refer to FIG. 2 and FIG. 4. Next, a Step 14 is performed: performing a first exposure treatment 130 to the LC layer 120 with a photomask 140. The photomask 140 includes a plurality of transparent patterns 142 and a plurality of shielding patterns 144. In the preferred embodiment, the first exposure treatment 130 includes a UV light treatment and thus linear-polarized UV lights are exemplarily used to irradiate the LC layer 120. However, those skilled in the art would easily realize that the first exposure treatment 130 can include other suitable treatment or suitable light source. In portions of the LC layer 120 that are corresponding to the transparent patterns 142, the photosensitive monomers 124 are to bond an end of the symmetrical base of the LC molecules 122 during the first exposure treatment 130. Thus the LC molecules 122 become a reactive LC monomer having a polymerizable group. The special reactive LC monomers are then polymerized by its polymerizable group and arranged toward an UV exposure direction. Consequently, a phase difference is caused. After performing the first exposure treatment 130, at least a first patterned retarder 120a is formed in the LC layer 120 as shown in FIG. 4. Furthermore, in portions of the LC layer 120 that are corresponding to the shielding patterns 144, the LC molecules 122, the photosensitive monomers 124, and the thermal reactive monomers 126 are impervious to the first exposure treatment 130.

Please refer to FIG. 2 again. In addition, a Step 13 can be performed depending on the coating result of the LC layer 120: Performing a pre-baking treatment. It is noteworthy that the pre-baking treatment is performed before the first exposure treatment 130. A process temperature of the pre-baking treatment is between about 40° C. and about 75° C. The pre-baking treatment is performed to remove excessive solvent from the LC layer 120 for reducing liquidity of the LC layer 120 that renders adverse impact to the first exposure treatment 130.

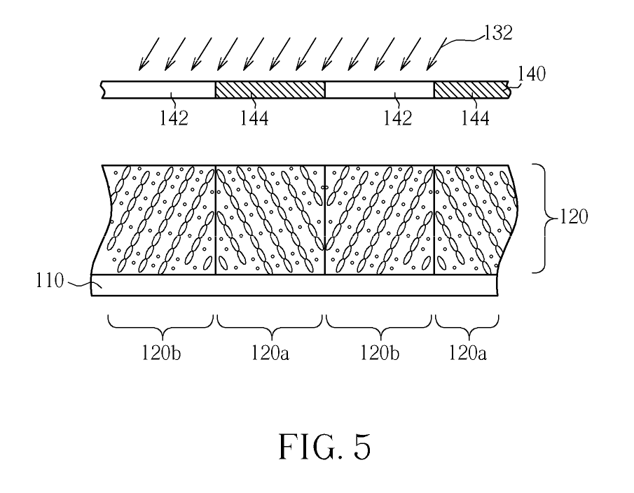

Please refer to FIG. 2 and FIG. 5. After forming the first patterned retarder 120a by performing the first exposure treatment 130, a second exposure treatment 132 is subsequently performed. The second exposure treatment 132 can also include a UV light treatment. In the preferred embodiment, linear-polarized UV lights are used to irradiate the LC layer 120, but not limited to this. It is noteworthy that the photomask 140 used in the first exposure treatment 130 can be used in the second exposure treatment 132. In accordance with the preferred embodiment, the photomask 140 is shifted a pitch before the second exposure treatment 132. Therefore the transparent patterns 142 of the photomask 140 are corresponding to those non-reacted portions of the LC layer 120 after the first exposure treatment 130. The pitch is decided according to a pixel size of the LCD panel to which the micro retarder is attached, but not limited to this. Those skilled in the art would easily realize that the other suitable photomask can be used in the preferred embodiment. Accordingly, a Step 16 is performed: Performing a second exposure treatment 132 to form at least a second patterned retarder 120b in the LC layer 120 as shown in FIG. 5. It is noteworthy that an exposure direction of the first exposure treatment 130 is different from an exposure direction of the second exposure treatment 132. Therefore a direction for phase difference of the second patterned retarder 120b is different from a direction for phase difference of the first patterned retarder 120a. In other words, the first patterned retarder 120a and the second patterned retarder 120b are alternately and repetitiously bar patterns which include distinctively different optical characteristics. The first patterned retarder 120a and the second patterned retarder 120b respectively provide left eye images and right eye images to a viewer on cooperation with polarized glasses. Thus the viewer obtains a stereoscopic vision due to the parallax of eyes. Accordingly, the arrangement of the first patterned retarder 120a and the second patterned retarder 120b is not limited to this. It is appreciated that any patterns and arrangement that are able to improve the stereoscopic images can be adopted in the present invention. Furthermore, the first patterned retarder 120a and the second patterned retarder 120b provided by the preferred embodiment render different phase retardations. For example, the first patterned retarder 120a provides the phase retardation of one-fourth wavelength (¼λ) while the second patterned retarder 120b provides the phase retardation of ¾λ. Or, the first patterned retarder 120a provides the phase retardation of ½λ while the second patterned retarder 120b provides the phase retardation of ¼λ, but not limited to this.

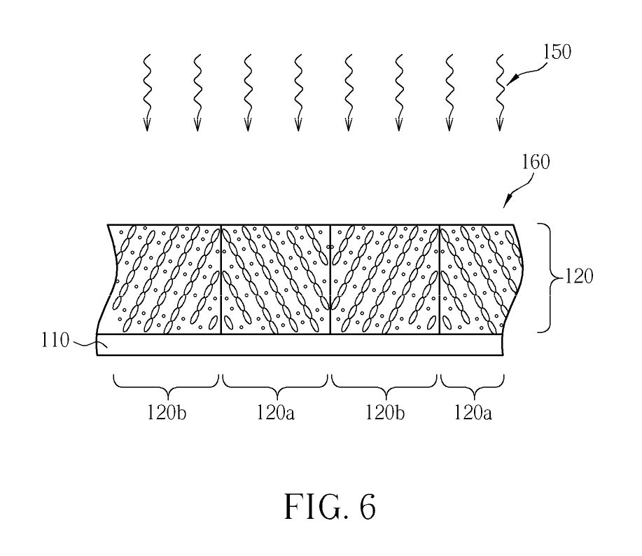

Please refer to FIG. 2 and FIG. 6. Then a Step 18 is performed: performing a baking treatment 150. The baking treatment 150 is performed after the second exposure treatment 132 and a process temperature of the baking treatment 150 is between about 100° C. and about 200° C. During the baking treatment 150, the thermal reactive monomers 126 in the LC layer 120 are polymerized and thus the LC layer 120 is cured. Consequently a micro retarder 160 without alignment layer including the first patterned retarder 120a and the second patterned retarder 120b is obtained.

According to the method for forming a micro retarder without alignment layer provided by the present invention, the patterned retarders 120a/120b are formed by being exposed to lights from different directions through the photomask 140. Furthermore, by polymerizing thermal reactive monomers 126 at the specific process temperature, the micro retarder 160 without alignment layer is obtained. Briefly speaking, the micro retarder 160 without alignment layer formed by the method of the preferred embodiment eliminates the conventional steps of forming and rubbing the PI layer, and thus the process efficiency and the process cost are both reduced.

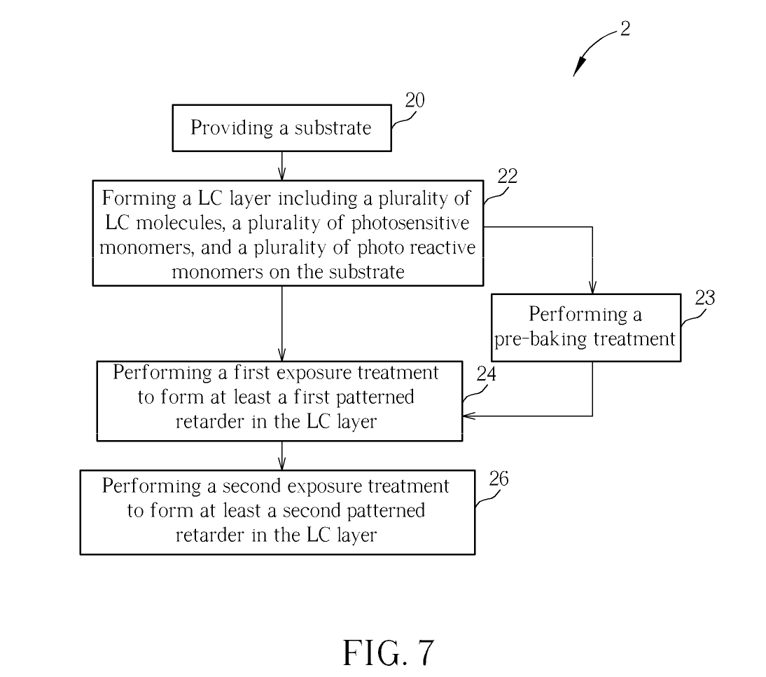

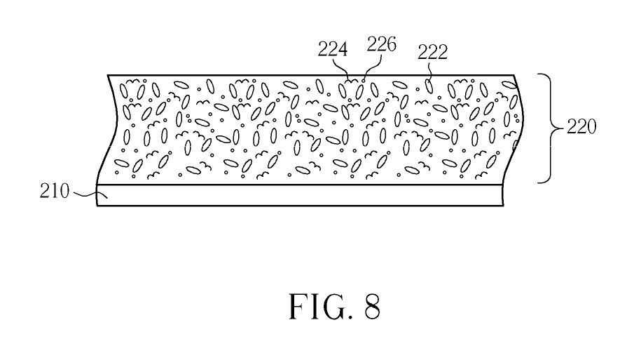

Please refer to FIGS. 7-10, which are drawings illustrating a method for forming a micro retarder without alignment layer provided by a second preferred embodiment of the present invention, wherein FIG. 7 is a flow chart of the method for forming a micro retarder without alignment layer. Please refer to FIG. 7 and FIG. 8. According to the method for forming a micro retarder without alignment layer 2 provided by the preferred embodiment, a Step 20 is performed: providing a substrate 210. Please note that the substrate 210 can include materials the same with the substrate 110 as mentioned above, therefore those details are omitted herein in the interest of brevity.

Please still refer to FIG. 7 and FIG. 8. A Step 22 is subsequently performed: forming a LC layer 220 on the substrate 210. The LC layer 220 includes a plurality of LC molecules 222, a plurality of photosensitive monomers 224, a plurality of photo reactive monomers 226, and solvent (not shown). The LC layer 220 is formed on the substrate 210 by coating method as mentioned in the first preferred embodiment. Consequently, the LC layer 220 obtains a uniform thickness. It is noteworthy that the thermal reactive monomers 126 in the LC layer 120 as mentioned in the first preferred embodiment are replaced by the photo reactive monomers 226 in accordance with the second preferred embodiment. As mentioned above, the LC molecules 222 include at least a pair of symmetrical base, the photosensitive monomers 224 include at least cinnamate or coumadin, and the photo reactive monomers 226 include at least acrylamide or acrylamide derivative, acrylate or acrylate derivative, methacrylate or methacrylate derivative.

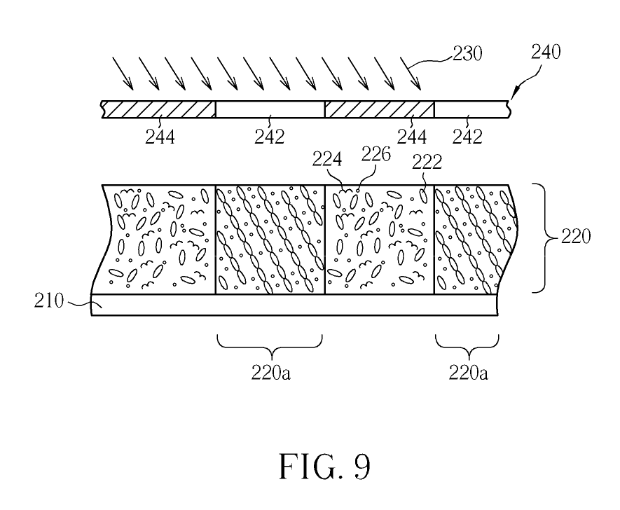

Please refer to FIG. 7 and FIG. 9. Next, a Step 24 is performed: performing a first exposure treatment 230 to the LC layer 220 with a photomask 240. The photomask 240 includes a plurality of transparent patterns 242 and a plurality of shielding patterns 244. In the preferred embodiment, the first exposure treatment 230 includes a UV light treatment. Accordingly linear-polarized UV lights are used to irradiate the LC layer 220. However, those skilled in the art would easily realize that the first exposure treatment 230 can include other suitable treatment or suitable light source. In portions of the LC layer 220 that are corresponding to the transparent patterns 242, the photosensitive monomers 224 are to bond an end of the symmetrical base of the LC molecules 222 during the first exposure treatment 230. Thus the LC molecules 222 become a reactive LC monomer having a polymerizable group. The special reactive LC monomers are then polymerized by its polymerizable group and arrange toward an UV exposure direction. Consequently, a phase difference is caused. After performing the first exposure treatment 230, at least a first patterned retarder 220a is formed in the LC layer 220 as shown in FIG. 9. It is noteworthy that because the LC layer 220 further includes the photo reactive monomers 226 according to the preferred embodiment, the photo reactive monomers 226 are polymerized and thus the first patterned retarder 220a is cured in the first exposure treatment 230. Furthermore, in portions of the LC layer 220 that are corresponding to the shielding patterns 244, the LC molecules 222, the photosensitive monomers 224, and the photo reactive monomers 226 are impervious to the first exposure treatment 230.

Please still refer to FIG. 7. In addition, a Step 23 can be performed depending on the coating result of the LC layer 220: Performing a pre-baking treatment. It is noteworthy that the pre-baking treatment is performed before the first exposure treatment 230. A process temperature of the pre-baking treatment is between about 40° C. and about 75° C. The pre-baking treatment is performed to remove excessive solvent from the LC layer 220 for reducing liquidity of the LC layer 220 that renders adverse impact to the first exposure treatment 230.

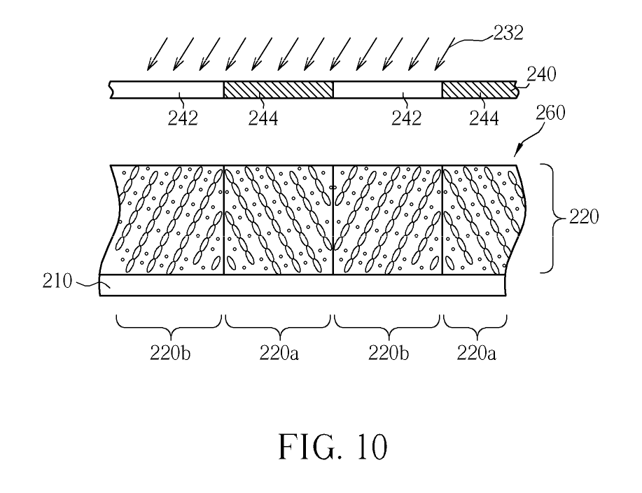

Please refer to FIG. 7 and FIG. 10. After forming the first patterned retarder 220a by performing the first exposure treatment 230, a Step 26 is subsequently performed: performing a second exposure treatment 232. The second exposure treatment 232 can also include a UV light treatment such as a linear-polarized UV light treatment in the preferred embodiment, but not limited to this. It is noteworthy that the photomask 240 used in the first exposure treatment 230 can be used in the second exposure treatment 232. In accordance with the preferred embodiment, the photomask 240 is shifted a pitch before the second exposure treatment 232. Therefore the transparent patterns 242 of the photomask 240 are corresponding to those non-reacted portions of the LC layer 220 after the first exposure treatment 230. The pitch is decided according to a pixel size of the LCD panel to which the micro retarder is attached, but not limited to this. Those skilled in the art would easily realize that the other suitable photomask can be used in the preferred embodiment. Subsequently, the Step 26 is performed by performing a second exposure treatment 232 to form at least a second patterned retarder 220b in the LC layer 220 as shown in FIG. 10. It is noteworthy that an exposure direction of the first exposure treatment 230 is different from an exposure direction of the second exposure treatment 232. Therefore a direction for phase difference of the second patterned retarder 220b is different from a direction for phase difference of the first patterned retarder 220a. In other words, the first patterned retarder 220a and the second patterned retarder 220b are alternately and repetitiously arranged bar patterns which include distinctly different optical characteristics. The first patterned retarder 220a and the second patterned retarder 220b respectively provide left eye images and right eye images to a viewer on cooperation with polarized glasses. Thus the viewer obtains a stereoscopic vision due to the parallax of eyes. Accordingly, the arrangement of the first patterned retarder 220a and the second patterned retarder 220b is not limited to this. It is appreciated that any patterns and arrangement that are able to improve the stereoscopic images can be adopted in the present invention. Furthermore, the first patterned retarder 220a and the second patterned retarder 220b provided by the preferred embodiment render different phase retardation. For example, the first patterned retarder 220a provides the phase retardation of ¼λ while the second patterned retarder 220b provides the phase retardation of ¾λ. Or, the first patterned retarder 220a provides the phase retardation of ½λ while the second patterned retarder 220b provides the phase retardation of ¼λ, but not limited to this.

In addition, since the LC layer 220 includes the photo reactive monomers 226 in accordance with the preferred embodiment, the photo reactive monomers 226 are polymerized and thus the second patterned retarder 220b is cured in the second exposure treatment 232. Consequently, a micro retarder 260 without alignment layer is obtained immediately after performing the second exposure treatment 232.

According to the method for forming a micro retarder 260 without alignment layer provided by the present invention, the patterned retarders 220a/220b are formed by being exposed to light from different direction through the photomask 240. Furthermore, by polymerizing the photo reactive monomers 226 during the two exposure treatments, the micro retarder 260 without alignment layer is obtained immediately after the second exposure treatment 232. Briefly speaking, the micro retarder 260 without alignment layer formed by the method of the preferred embodiment eliminates the conventional steps of forming and rubbing the PI layer, even economizes the baking treatment that conventionally performed to cure the micro retarder, thus the process efficiency and process cost are both substantially reduced.

According to the method for forming a micro retarder without alignment layer provided by the present invention, a LC layer having the LC molecules, the photosensitive monomers, and the thermal reactive monomers, or a LC layer having the LC molecules, the photosensitive monomers, and the photo reactive monomers is provided. Accordingly, the photosensitive monomers and the LC molecules in the LC layer are polymerized and arranged toward different exposure directions by performing the exposure treatments. Thus the first patterned retarder and the second patterned retarder are formed. The method provided by the present invention further has an advantage of having either the thermal reactive monomers or the photo reactive monomers in the LC layer. In the preferred embodiment that the LC layer includes the thermal reactive monomers, the micro retarder without alignment layer is formed by performing the baking treatment after forming the first patterned retarder and the second patterned retarder. In the preferred embodiment that the LC layer includes the photo reactive monomers, the micro retarder without alignment layer is immediately obtained after forming the first exposure treatment and the second exposure treatment.

Those skilled in the art will readily observe that numerous modifications and alterations of the device and method may be made while retaining the teachings of the invention.

What is claimed is:

1. A method for manufacturing a micro retarder without alignment layer comprising:
providing a substrate;
forming a liquid crystal (LC) layer on the substrate, the LC layer comprising a plurality of LC molecules, a plurality of photosensitive monomers, and a plurality of thermal reactive monomers;
performing a first exposure treatment to form at least a first patterned retarder in the LC layer;
performing a second exposure treatment to form at least a second patterned retarder in the LC layer; and
performing a baking treatment to form the micro retarder without alignment layer.

2. The method for manufacturing a micro retarder without alignment layer according to claim 1, further comprising performing a pre-baking treatment before the first exposure treatment.

3. The method for manufacturing a micro retarder without alignment layer according to claim 1, wherein the first exposure treatment further comprises using a photomask to form the first patterned retarder.

4. The method for manufacturing a micro retarder without alignment layer according to claim 3, further comprising shifting the photomask a pitch before performing the second exposure treatment.

5. The method for manufacturing a micro retarder without alignment layer according to claim 1, wherein the LC molecules comprise at least a pair of symmetrical base.

6. The method for manufacturing a micro retarder without alignment layer according to claim 1, wherein the photosensitive monomers comprise at least cinnamate or coumadin.

7. The method for manufacturing a micro retarder without alignment layer according to claim 1, wherein the thermal reactive monomers comprise at least styrene or styrene derivative.

8. The method for manufacturing a micro retarder without alignment layer according to claim 1, wherein an exposure direction of the first exposure treatment is different from an exposure direction of the second exposure treatment.

9. The method for manufacturing a micro retarder without alignment layer according to claim 1, wherein the first exposure treatment and the second exposure treatment respectively comprise an UV light treatment.

10. A method for manufacturing a micro retarder without alignment layer comprising:
providing a substrate;
forming an LC layer on the substrate, the LC layer comprising a plurality of LC molecules, a plurality of photosensitive monomers, and a plurality of photo reactive monomers;
performing a first exposure treatment to form at least a first patterned retarder in the LC layer; and
performing a second exposure treatment to form at least a second patterned retarder in the LC layer.

11. The method for manufacturing a micro retarder without alignment layer according to claim 10, wherein the first exposure treatment further comprises using a photomask to form the first patterned retarder.

12. The method for manufacturing a micro retarder without alignment layer according to claim 11, further comprising shifting the photomask a pitch before the second exposure treatment.

13. The method for manufacturing a micro retarder without alignment layer according to claim 10, wherein the LC molecules comprise at least a pair of symmetrical base.

14. The method for manufacturing a micro retarder without alignment layer according to claim 10, wherein the photosensitive monomers comprise at least cinnamate or coumadin.

15. The method for manufacturing a micro retarder without alignment layer according to claim 10, wherein the photo reactive monomers comprise at least acrylamide or acrylamide derivative, acrylate or acrylate derivative, methacrylate or methacrylate derivative.

16. The method for manufacturing a micro retarder without alignment layer according to claim 10, wherein an exposure direction of the first exposure treatment is different from an exposure direction of the second exposure treatment.

17. The method for manufacturing a micro retarder without alignment layer according to claim 10, wherein the first exposure treatment and the second exposure treatment respectively comprise an UV light treatment.

18. The method for manufacturing a micro retarder without alignment layer according to claim 10, further comprising performing a pre-baking treatment before the first exposure treatment.
